(19) United States
(12) Patent Application Publication
(10) Pub. No.: US 2009/0090112 A1
(43) Pub. Date: Apr. 9, 2009

(54) SYSTEM AND METHOD FOR CRYOGENIC ENHANCEMENT TO MECHANICAL FREEZERS

(76) Inventors: JOHN MARTIN GIRARD, Downers Grove, IL (US); DAVID JOSEPH KING, Frankfort, IL (US); THEODORE HALL GASTEYER, III, Naperville, IL (US); JOHN NICHOLAS HRYN, Naperville, IL (US); RAYMOND JAMES SCHAEFFER, Lake Zurich, IL (US); GERALD KUZYK, Montreal (CA); GLENN TOYOSHI SAMESHIMA, Oak Park, IL (US); ROBERT J. CHAMBERLAIN, Oak Forest, IL (US)

Correspondence Address: PRAXAIR, INC.;LAW DEPARTMENT - M1 557, 39 OLD RIDGEBURY ROAD, DANBURY, CT, 06810-5113, US

(21) Appl. No.: 12/207,535

(22) Filed: Sep. 10, 2008

Related U.S. Application Data
(63) Continuation-in-part of application No. 11/899,598, filed on Sep. 6, 2007.

(51) Int. Cl. F17C 7/04; F25B 19/00; F25D 13/06; F25D 25/04

(52) U.S. Cl. 62/48.1; 62/51.1; 62/380; 62/63

(57) ABSTRACT

A cryogenic enhanced mechanical freezer system and method are provided. The disclosed system includes a mechanical freezer compartment adapted for freezing food products on a conveyor, a cryogen injection system adapted to directly inject cryogen into a shrouded zone proximate the conveyor in the mechanical freezer compartment, an exhaust system adapted to rapidly evacuate cryogen vapors from the freezer compartment; and a freezer control system adapted to operatively control the exhaust system and cryogen injection system in response to selected inputs so as to not adversely affect the mechanical refrigeration capacity associated with the mechanical freezer. The selected inputs may include user inputs as well as inputs received from one or more temperature sensors disposed in the freezer compartment and a gas analyzer adapted to monitor concentrations of selected gases within the freezer compartment. Access to the freezer compartment is prevented using a door interlock arrangement during any cryogen injection operations and when the atmosphere in the freezer compartment is not safe as determined by the gas analyzer.

### CROSS REFERENCE TO RELATED APPLICATIONS

The present application is a continuation-in-part application to U.S. patent application Ser. No. 11/899,598 filed on Sep. 6, 2007, the disclosure of which is incorporated by reference herein.

### FIELD OF THE INVENTION

The present invention relates to refrigeration and freezing systems, and more particularly to a system and method for the cryogenic enhancement of mechanical freezers with liquid nitrogen or carbon dioxide.

### BACKGROUND OF THE INVENTION

In typical mechanical refrigeration or freezing systems there are inherent performance limitations on the ability of the freezer systems to cool foodstuffs. One such limitation arises when excessive ice forms on the refrigeration coils. Excessive ice on the coils requires the freezer system to be defrosted on a regular basis which interrupts and adversely impacts food production. Another common freezer performance limitation occurs when the condenser unit in the mechanical freezer system is operating at full capacity and the freezer system cannot adequately reject any excess beat from the condenser unit. Such equipment issues often result in limitations of the refrigeration potential for the freezer system which, in turn, is often a limiting factor in the food production line.

Prior art attempts to solve these problems of system inefficiency involved the use of a combination freezer that employs both cryogenic refrigeration techniques in conjunction with mechanical refrigeration. In such prior art cryogenic enhancement systems, a cryogenic freezer and a mechanical freezer are typically disposed into a single enclosure with each freezer operating independently. See for example, U.S. Pat. No. 4,856,285 (Acharya et al.); U.S. Pat. No. 4,858,445 (Rasovich) and U.S. Pat. No. 5,170,631 (Lang et al.).

For example, in both the Acharya et al. and Rasovich disclosures, the cryogen freezer is segregated from the mechanical freezer and any cryogenic vapor present in the combination freezer is used indirectly to supplement the mechanical refrigeration. Because the cryogenic vapors are used to effect cooling in an indirect manner, the cryogenic vapors and the mechanically refrigerated air are controlled and managed separately.

The Lang et al. prior art system uses cryogen vapor in a direct refrigeration capacity, but the cryogenic freezer is also spatially and operationally segregated from the mechanical freezer which keeps the cryogenic vapors and the mechanically refrigerated air separate. Moreover, the Lang et al. reference does not address the need to safely manage the hazardous atmosphere that arises when cryogenic vapors and mechanically refrigerated air is mixed.

What is needed, therefore, is a safe and relatively low cost, integrated cryogenic enhancement to mechanical freezer systems that would combine cryogenic vapors and mechanically refrigerated air to affect the freezing of foodstuffs. The combined effect of cryogenic vapor and mechanically refrigerated air operates to increase freezer capacity and freezer performance over a pure mechanical freezer without costly modification to the mechanical freezer.

### SUMMARY OF THE INVENTION

The present invention may be characterized as a cryogenic enhanced mechanical freezer system comprising: (i) a mechanical freezer including a conveyor disposed within a mechanical freezer compartment; (ii) an enclosure disposed around a portion of the conveyor in the mechanical freezer compartment to define a shrouded zone; (iii) a cryogen injection system adapted to directly inject cryogen into the shrouded zone; (iv) one or more temperature sensors disposed in the freezer compartment and adapted to ascertain the temperature within the mechanical freezer compartment; (v) an exhaust system having a first exhaust blower disposed proximate to the shrouded zone and adapted to evacuate cryogen vapors originating from the shrouded zone to a location outside the mechanical freezer compartment; and (vi) a freezer control system adapted to control the mechanical freezer, the exhaust system, and cryogen injection system in response to inputs from the temperature sensors and wherein the exhaust system and cryogen injection system are proportionally controlled.

In another aspect the present invention may be characterized as a cryogenic enhanced mechanical freezer system comprising: (i) a mechanical freezer adapted for freezing food products, the mechanical freezer including a conveyor disposed within a mechanical freezer compartment; (ii) a cryogen injection system including a plurality of nozzles disposed proximate the conveyor to define one or more localized cryogen zones, the cryogen injection system adapted to inject cryogen directly at the food products within the one or more localized cryogen zones; (iii) a temperature sensor disposed in the freezer compartment to ascertain the temperature within the mechanical freezer compartment; (iv) an exhaust system having an exhaust blower adapted to evacuate cryogen vapors originating from the localized cryogen zones to a location outside the mechanical freezer compartment; and (v) a freezer control system adapted to control the mechanical freezer, the exhaust system, and cryogen injection system in response to inputs from the temperature sensor to maintain the mechanical freezer compartment at or above a prescribed temperature set point so as to not adversely affect the mechanical refrigeration capacity.

In yet another aspect, the invention is characterized as a method of freezing foodstuffs in a mechanical freezer comprising steps of: (i) mechanically refrigerating a freezer compartment; (ii) sensing the temperature in the freezer compartment; (iii) controllably injecting a cryogen directly into a shrouded zone in the freezer compartment proximate the foodstuffs based on the temperature of the freezer compartment to cryogenically enhance the freezing of the foodstuffs; and (iv) controllably exhausting the cryogen vapors from the shrouded zone in the freezer compartment wherein the injecting of the cryogen and exhausting of the cryogen vapors is controlled in response to the temperature in the freezer compartment to maintain the freezer compartment at or above a prescribed temperature set point so as to not adversely affect the mechanical refrigeration capacity associated with the mechanical freezer system.

### BRIEF DESCRIPTION OF THE DRAWINGS

While the specification concludes with claims distinctly pointing out the subject matter that Applicants regard as their invention, it is believed that the invention will be better understood when taken in connection with accompanying drawings in which:

FIG. 1 is a schematic view of the present cryogenic enhanced mechanical freezer system in accordance with an embodiment of the invention;

FIG. 2 is a schematic view of a control system suitable for use with an embodiment of the invention;

FIG. 3 is a detailed view of the preferred door interlock scheme used in an embodiment of the invention;

FIG. 4 is a flowchart delineating the preferred steps involved in the safe operation of cryo-boost enhancement;

FIG. 5 is a partial cut-away illustration of a cryogen injection system including a cryogen structure or enclosure defining a shrouded cryogen zone near the product exit of a mechanical tunnel freezer; and

FIG. 6 is a partial cut-away illustration of a cryogen injection system including a cryogen structure or enclosure defining a shrouded cryogen zone over a portion of a conveyor near the top of a mechanical spiral freezer.

### DETAILED DESCRIPTION

The following description sets forth the best mode presently contemplated for practicing the present system and method for cryogenic freezer enhancement. The disclosure is not to be taken in a limiting sense, but rather should be read in conjunction with the appended claims.

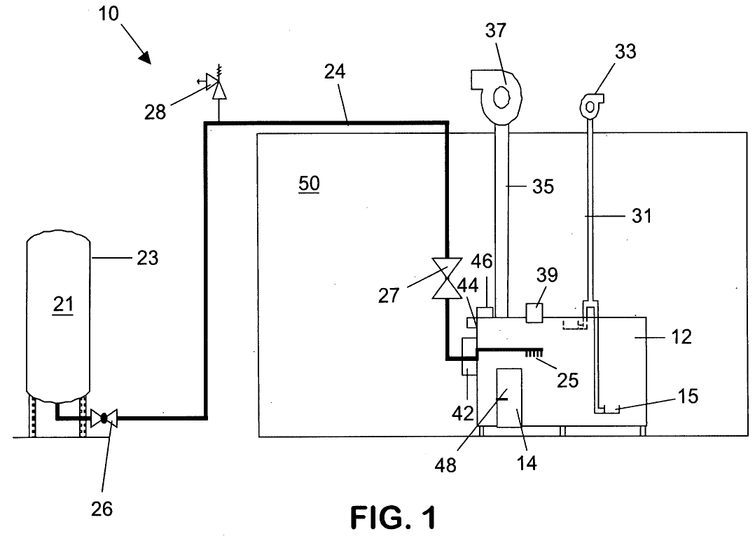

With reference to FIG. 1, there is shown an embodiment of the present cryogenic freezer enhancement system 10. As seen therein, the cryogenic freezer enhancement system 10 includes a mechanical-based freezer compartment 12 having a door 14 or other means for access and egress to the interior of the freezer compartment 12. The freezer compartment 12 may include various conveyors or other structures disposed therein for containing food product. The freezer system 10 further includes a cryogen injection system adapted to introduce a cryogen into the freezer compartment 12 to treat the food product as well as an exhaust subsystem and a freezer control subsystem.

In the illustrated embodiment, the cryogen injection subsystem preferably includes a source of cryogen 21, such as liquid nitrogen or carbon dioxide, contained within a storage vessel 23 and coupled via a cryogen circuit 24 to cryogen nozzles 25 disposed within the freezer compartment 12. A plurality of valves, such as shut-off valves 26, control valves 27, safety relief valves 28, etc. are disposed along the cryogen circuit and operatively coupled to the freezer control panel 42. The direct injection of the cryogen into a mechanically refrigerated freezer is an efficient and cost effective means to improve overall freezer performance relative to production capacity. The refrigeration capacity of the cryogen, as applied directly to the mechanically refrigerated space in the freezer compartment, works in conjunction with and boosts the mechanical refrigeration capacity. However, in many instances, it may be necessary or advantageous to further seal the mechanical freezer compartment so as to prevent escape of cryogen vapors from the freezer compartment to the outside via leakage.

The preferred process to boost the refrigeration capacity in a mechanical freezer with a cryogen, such as liquid nitrogen or carbon dioxide is designed to operate the mechanical refrigeration system at the optimum conditions to maximize efficiency, which is typically at a prescribed set point temperature. The cryo-boost process is preferably operated at a temperature control point slightly warmer than the mechanical refrigeration system set point temperature. Setting the cyro-boost temperature control point slightly warmer than the mechanical refrigeration system set point temperature, the demand for injection of nitrogen or carbon dioxide into the freezer compartment 12 is controlled without adversely influencing the operation of the mechanical refrigeration system. The warmer temperature control point of the cryo-boost process ensures the mechanical refrigeration system operates at or near maximum efficiency. Nitrogen or carbon dioxide is added only when the refrigeration demand is near or exceeds the mechanical refrigeration capacity. When the refrigeration demand diminishes, the cryogen flow will terminate before the mechanical refrigeration system unloads since the cryo-boost control temperature is warmer than the mechanical refrigeration temperature set point.

In the illustrated embodiment, the exhaust system preferably includes a primary cryogen exhaust duct 31 and primary exhaust blower 33 adapted to collect and discharge expended cryogen vapors during the operation of the freezer. The illustrated exhaust system further includes an auxiliary exhaust duct 35 and auxiliary exhaust blower 37 adapted for the rapid evacuation of the cryogen vapor and refrigerated air within the freezer compartment upon activation. Activation of the auxiliary exhaust is preferably initiated as a command from the controller in response to various user inputs or automatic safeguards programmed into the controller. Additional exhaust blowers including a cold exhaust or dedicated cryogen exhaust could also be incorporated into the cryo-enhanced mechanical freezer to promptly remove cryogen vapors and reduce pressure from within the mechanical freezer compartment shortly after injection of the cryogen. Promptly removing the injected cryogen vapors reduces leakage of the vapors from the freezer compartment that may occur as a result of the higher pressure within the freezer compartment.

The rapid exhaust blower 37 is preferably sized to evacuate the atmosphere within the mechanical freezer compartment 12 in a few minutes, preferably less than four minutes, and replace the atmosphere with a source of make-up air. From a safety standpoint, evacuation of the mechanical freezer compartment atmosphere should require a 4 to 5 times volume exchange to ensure a safe and breathable atmosphere in the freezer compartment. For example, a 2000 cubic foot freezer preferably employs an auxiliary exhaust blower sized at about 4000 cubic feet per minute. When the rapid exhaust blower is activated, it would preferably run for a minimum of 2 minutes in order to achieve the 4 times volume exchange when the cryogen injection is de-activated. Preferably, a make-up air port 39 connected to a source of make-up air is also included as part of the exhaust subsystem for use when the rapid exhaust blower 37 is activated. Additional safety precautions may be invoked that keep one or more of the exhaust blowers operating whenever the door 14 to the freezer compartment 12 is open allowing access to the freezer compartment 12.

Both the primary cryogen exhaust and the auxiliary rapid exhaust are adapted to prevent most of the cryogenic vapors injected into the freezer compartment 12 from filling the process area 50 surrounding the freezer compartment 12. Both the primary exhaust duct 31 and the auxiliary exhaust duct 35 carry away and vent the evacuated streams out of the freezer compartment 12 and away from the process area 50. Ideally, the location of the exhaust pickups for the rapid exhaust is proximate the lower pressure region of the freezer compartment 12 and often near the floor or bottom of the freezer compartment 12 as both preferred cryogens, namely nitrogen and carbon dioxide, are denser than air at temperatures near −30° F. and tend to settle toward the bottom of the freezer. Alternatively, a dedicated cryogen exhaust may be co-located with the cryogen injection system. To maximize the effectiveness of the rapid exhaust in replacing the air within the freezer compartment, the make-up air preferably should enter from a duct 39 or port at the top of the freezer compartment 12 while the colder cryogenic vapors exit from the lower portion of the freezer compartment 12.

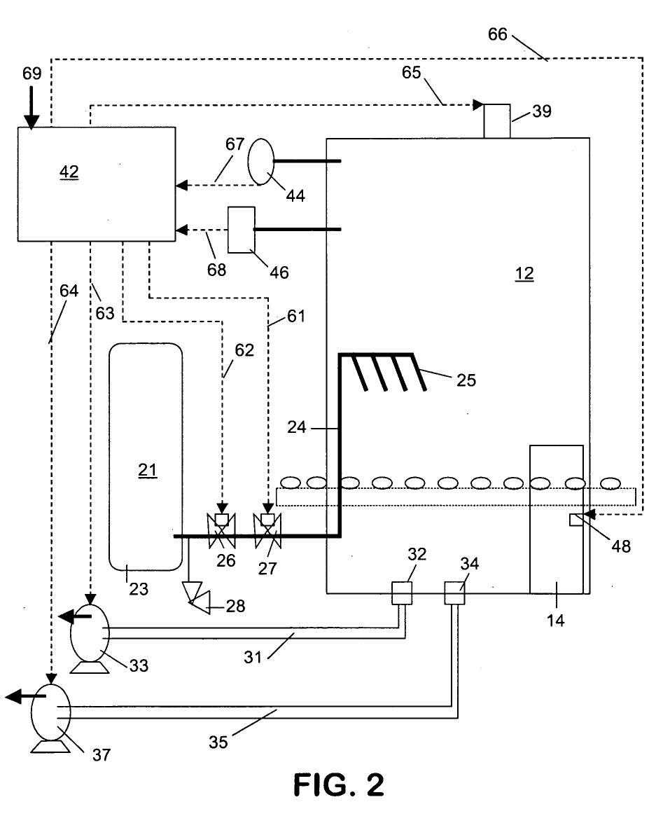

The freezer control subsystem preferably includes a microprocessor-based control panel 42 adapted to receive a plurality of inputs including, as a minimum, a temperature sensor input and a gas analyzer input as well as various user inputs and control the operation of the cryogen enhanced mechanical freezer system based on such inputs. As seen in FIGS. 1 and 2, a temperature sensor 44 and a gas analyzer 46 are coupled as inputs to the freezer control panel 42. Other inputs representing or corresponding to the freezing or refrigeration parameters are also used in the present freezer control subsystem. Such other inputs may include, for example, characteristics of the cryogen used, temperature or other characteristics of the product being treated, or operational characteristics of the processing area, associated equipment and components thereof.

The freezer control subsystem operatively controls the flow of cryogen in the cryogen circuit 24 and injection of the cryogen into the freezer compartment 12 by controlling selected valves 26, 27, 28 in response to the various inputs, identified above. In the preferred embodiment, the amount of cryogen injected into the freezer compartment 12 is based on the temperature in the freezer compartment 12, as ascertained by the temperature sensor 44, such that the efficiency of the mechanical refrigeration system is optimized. This cryo-boost enhancement is preferably a user initiated or selected process that can be turned on or off depending on the refrigeration needs for the product within the freezer compartment. For example, during high production runs or during summer months when temperatures of the processing area have increased, supplemental refrigeration capacity via cryogen enhancement or cryo-boost is both useful and cost-effective to achieve the desired temperature of the product.

The freezer control subsystem also controls the rapid exhaust and other safety features of the cryogen enhanced freezer system 10 in response to selected inputs and operating parameters. When the cryo-boost feature is activated, cryogen injection via nozzles 25 into the freezer compartment 12 is precisely controlled based, in part, on the temperature inside the freezer compartment 12. The cryo-boost enhancement process remains active until the control system or operator turns off the cryo-boost enhancement or someone attempts to enter the freezer compartment 12. Upon either of these events, a rapid exhaust feature in the blower 37 is activated to purge the atmosphere inside the freezer compartment 12 within a short period of time, preferably in about four minutes or less.

In the present embodiment, access into the freezer compartment 12 is via the door 14 or other egress is strictly controlled. When the cryo-boost enhancement is activated, the doors 14 to the freezer compartment 12 are inaccessible from the outside. More specifically, access to the freezer compartment 12 from the outside is prevented by covering and securing the door handles with appropriate interlocks 48 when the atmosphere within the freezer compartment 12 is oxygen-deficient.

In addition, a gas analyzer 46 operatively coupled to the freezer control panel 42 and the door interlocks 48 is also provided. In this manner, gas analyzer is used as an input to control (e.g. stop) the rapid exhaust as well as to limit access to the freezer compartment 12 via the door 14. In the preferred embodiment, access to the door 14 to the freezer compartment 12 remains inaccessible from the outside so long as the gas analyzer 46 indicates the presence of an oxygen-deficient atmosphere inside the freezer compartment 12. In the liquid nitrogen embodiment of the cryo-boost enhancement process, the gas analyzer 46 is preferably an oxygen gas analyzer which will allow access to the freezer compartment 12 only when the cryo-boost enhancement is deactivated (i.e. OFF) and there is sufficient oxygen in the freezer compartment 12 to allow a safe breathing environment. Alternatively, in the carbon dioxide embodiment of the cryo-boost enhancement process, the gas analyzer 46 is a carbon dioxide gas analyzer which will deny access through the door 14 of the freezer compartment 12 when the cryo-boost enhancement process is activated (i.e. ON) or until the concentration of the carbon dioxide is below a safe threshold level.

In FIG. 2 there is shown another schematic of an embodiment of the cryogen enhanced mechanical freezer highlighting some of the freezer control aspects of the present system and process. As seen therein, control panel 42 is adapted to receive various inputs including, as a minimum, selected user inputs 69; temperature sensor inputs 67; and gas analyzer inputs 68. As indicated above, the user inputs 69 represent or correspond to the freezing or refrigeration parameters such as, temperature, flow and type of cryogen, refrigeration requirements of the product being frozen etc. The preferred control panel 42 is a microprocessor based control unit having adapted for receiving selected inputs and generating a series of commands or instructions 61, 62, 63, 64, 65, 66 to operate the cryo-boost enhancement process. The control panel 42 also preferably includes appropriate user interfaces such as a display screen and operator buttons (not shown) as well as suitable data and instruction storage means.

Using one or more of the above identified inputs, the freezer control subsystem operationally controls using output commands 61,62,63,64,65,66 the primary cryogen exhaust blower 33; the rapid exhaust blower 37; a cryogen injection; the make-up air replenishment; and the interlocks 48 on the freezer doors 14 via commands or outputs from the control panel 42. Control of the cryogen injection is operatively controlled by controlling the flow of cryogen 21 from the source of cryogen 23 through a cryogen circuit 24 that includes plurality of flow control and safety valves 26, 27, 28 and to nozzles 25 adapted to inject the cryogen into the freezer compartment proximate the food product to be treated. Control of the cryogen and air flow out of the freezer compartment 12 is governed by the primary exhaust pickup 32; primary exhaust duct 31; primary cryogen exhaust blower 33; the rapid exhaust pickup 34; rapid exhaust duct 35; and rapid exhaust blower 37. Make-up air to replace the atmosphere vented via the exhausts is operatively controlled by governing the flow through the intake duct 39 or port.

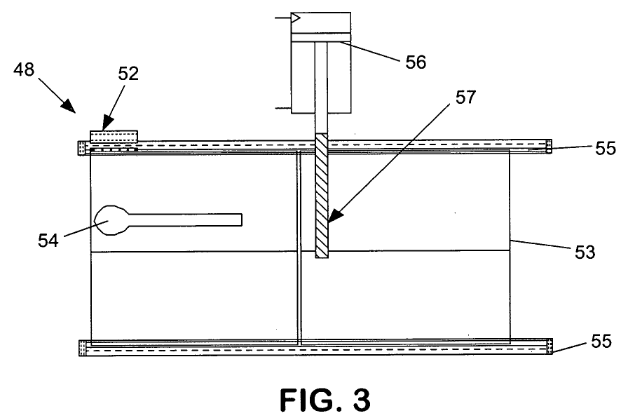

Knowing the status and condition of the freezer door position is important for safety considerations. Such status and conditions include whether the freezer door 14 is open or closed and whether the freezer door 14 is accessible or inaccessible from the outside. FIG. 3 depicts an embodiment of the interlocks 48 used in conjunction with the above-described cryogenic enhanced mechanical freezer system. In the illustrated embodiment, a proximity switch 52 is disposed on each freezer door 14 and coupled as an input to the freezer control panel 42. The proximity switch 52 monitors the position of the freezer door 14 to the freezer compartment 12.

The door interlock 48 includes a stainless steel cover 53 securely attached to the freezer proximate the door handle 54 with one or more guides 55 and a retaining mechanism. The cover 53 is adapted to move between a first position that shrouds the door handle 54 and a second position exposing the door handle 54. In the unlocked position, the cover 53 easily slides, rotates or otherwise exposes the door handle 54 to allow access to the door handle 54 by a person desiring entry to the freezer compartment 12. However, in the locked position, the cover 53 is retained in a position that prevents access to the door handle 54 by a person thereby preventing access or entry to the freezer compartment 12.

In the illustrated embodiment, the retaining mechanism comprises a small pneumatic cylinder 56 operatively actuated by commands from the freezer control panel 42. When the pneumatic cylinder 56 is actuated, a rod 57 extends and engages the cover 53 to physically lock the cover 53 over the door handle 54 and prevent access to the freezer compartment 12. When the atmosphere in the freezer compartment 12 is safe, the freezer control panel 42 de-energizes the pneumatic cylinder 56 and retracts the rod 57 allowing the cover 53 to move and expose the door handle 54. Alternate arrangements of the door interlock utilize a magnetic latch that when energized prevents access to the freezer from the outside.

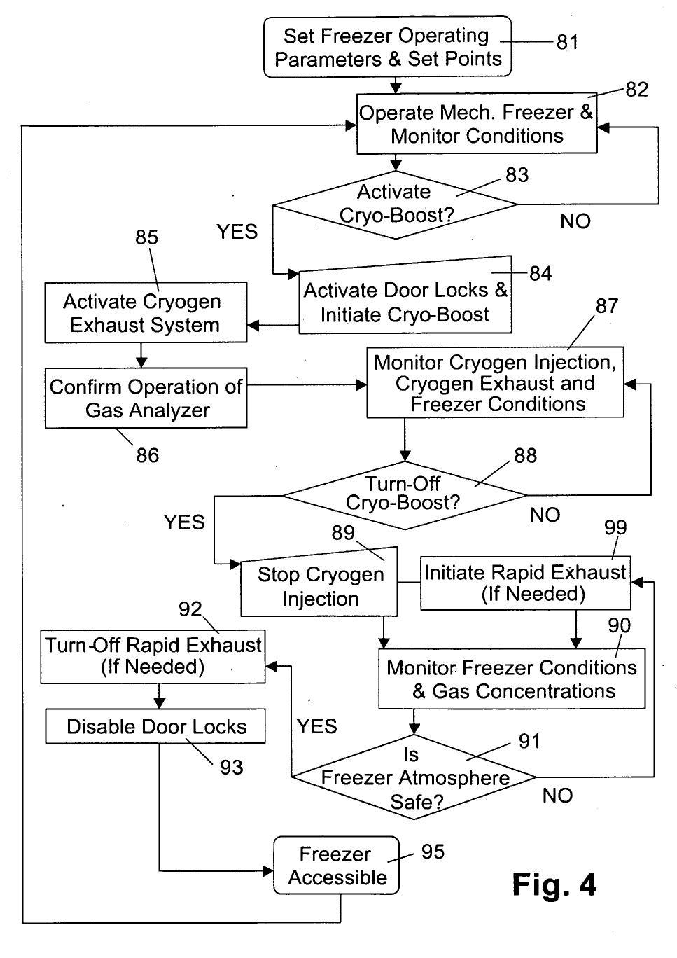

Turning now to FIG. 4 there is shown a flowchart broadly characterizing the control logic involved in the safe operation of cryo-boost enhancement process. A preliminary step in the depicted control process is to establish the operating parameters, temperature control points, and temperature set points for the freezer (Block 81). Such operating parameter setting is preferably accomplished via user inputs to the control panel of the freezer system. The cryo-boost control process involves operating the mechanical freezer while selected operating conditions, namely temperatures within the freezer compartment and/or food product are monitored (Block 82). During such freezer operation, the microprocessor based control unit continually inquires whether the conditions exist for activation of the cryo-boost enhancement (Block 83). If activation of cryo-boost is not desired, the freezer control subsystem continues to monitor operating conditions. On the other hand, if operating conditions dictate that the cryo-boost enhancement process is to be activated, the freezer control subsystem activates the door interlocks and initiates the cryo-boost process (Block 84). Upon initiation of the cryo-boost process, the cryogen exhaust is activated (Block 85) and the gas analyzer is active (Block 86).

The freezer control subsystem then proceeds to monitor the operating conditions of the freezer as well as control both the cryogen injection subsystem and cryogen exhaust (Block 87). During such cryo-boost enhancement operation, the microprocessor based control unit continually inquires whether the conditions exist for stopping or de-activating the cryo-boost process (Block 88). If operating conditions dictate continued operation of the cryo-boost process, the freezer control subsystem continues to monitor the operating conditions of the freezer and control the cryogen injection subsystem and cryogen exhaust (Block 87). However, if operating conditions dictate stopping or de-activating the cryo-boost process, the freezer control subsystem ceases further injection of cryogen (Block 89) and if warranted, initiates the rapid exhaust (Block 99). Initiation of the quick or rapid exhaust is in response to a command from the freezer control subsystem that is based on user inputs or a prescribed set of operating conditions. During the shut-down of the cryo-boost process, the freezer control subsystem continues to monitor the operating conditions of the freezer (Block 90) including appropriate temperatures and selected gas concentrations within the freezer compartment, as determined from the gas analyzer. Only when the atmosphere within the freezer compartment has been determined to be safe (Block 91), the freezer control subsystem proceeds to turn off the rapid exhaust (Block 92) if necessary, and disable the door interlocks (Block 93). At this point the freezer compartment is accessible (Block 95). The other exhaust blowers, however, may continue to operate after the door interlocks are disabled. In addition, the freezer control subsystem continues to monitor the operating conditions of the freezer (Block 82) in case further engagement of the cryo-boost process is needed.

While the addition of cryogen to a mechanical freezer supplements the overall refrigeration capacity of the freezer, it also has the potential to introduce adverse or unwanted conditions. For example, introduction of cryogen increases the pressure within the freezer compartment that could lead to leakage of vapors from the freezer compartment. Also, if the temperature in the freezer is too low, the efficiency of the mechanical refrigeration may be adversely affected.

Mitigating these adverse conditions associated with cryogen introduction into a mechanical freezer is achieved with the precise control of cryogen injection system and the exhaust system to maintain the mechanical freezer compartment at or above a prescribed temperature set point and optimized pressure.

Although the present control scheme is primarily concerned with controlling the cryogen injection, the cryogen exhaust, and limiting access to the freezer compartment during cryogen boost or cryogen enhancement operations, it is also contemplated that the present control scheme can be employed to concurrently control other equipment, such as transition fans, product conveyors, etc. In addition, control parameters other than operating temperature of the freezer may be used to control cryogen injection and exhaust subsystems during cryogen enhancement operations.

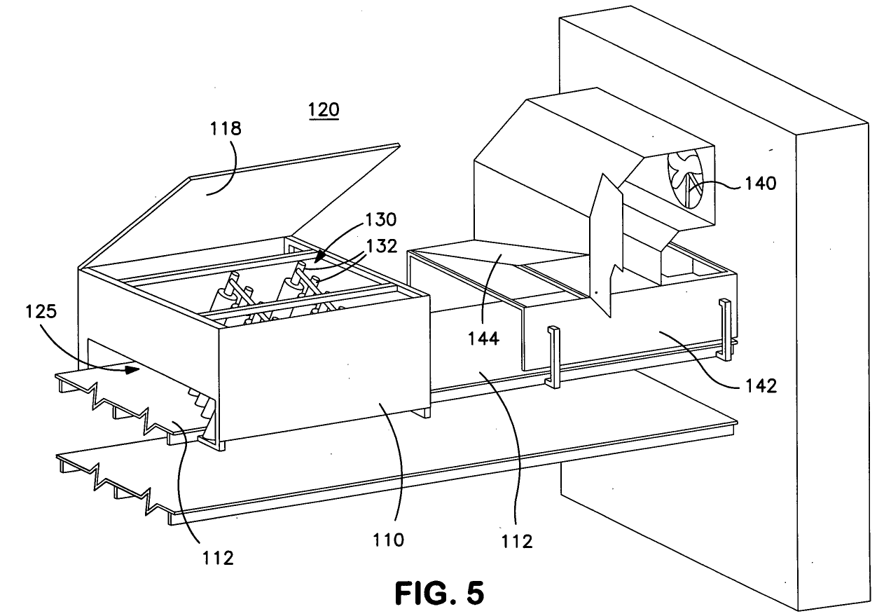

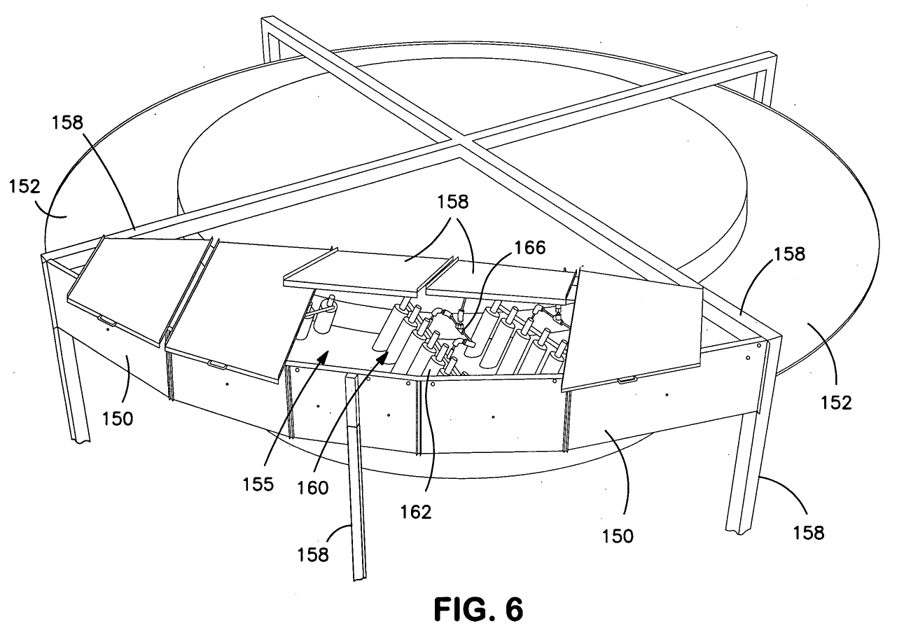

Turning to FIGS. 5 and 6 there are shown partial illustrations of further embodiments of the cryogen enhanced mechanical freezer systems that include a cryogen structure or enclosure defining a localized shrouded cryogen zone and a dedicated cryogen exhaust. In FIG. 5, the cryogen structure or enclosure 110 is disposed over a portion of the conveyor 112 in a mechanically refrigerated tunnel freezer and preferably proximate the exit of the product conveyor 112 from the freezer compartment 120. The cryogen structure or enclosure 110 defines a shrouded cryogen zone 125 where the cryogen, such as carbon dioxide or nitrogen is injected directly at the product transported on the conveyor 112 within the shrouded cryogen zone 125 by means of a cryogen injection system 130. The illustrated cryogen structure or enclosure 10 defines an entrance through which product on the conveyor 112 is brought within the shrouded cryogen zone 125 and an exit through which the product on the conveyor 112 leaves the shrouded cryogen zone 125 after exposure to the cryogen.

The cryogen injection system 130 preferably includes a plurality of injection nozzles 132 each coupled to a cryogen manifold. A source of cryogen (not shown) is supplied via conduits to the cryogen manifold. The cryogen injection system 130 is preferably controlled by a micro-processor based controller (not shown) that governs the cryogen injection profiles or patterns. The cryogen structure or enclosure 110 preferably includes one or more access doors 118 to facilitate periodic cleaning of the shrouded cryogen zone 125, cryogen injectors 132 and conveyor 112.

Proximate to the shrouded cryogen zone 125 and preferably downstream of the cryogen structure or enclosure 110 along the conveyor 112 is a cryogen exhaust arrangement that includes an exhaust blower 140 and an exhaust housing 142. This cryogen exhaust blower 140 is similar in function to the auxiliary exhaust blower discussed above, with reference to FIG. 1, and optionally includes the rapid exhaust feature that can evacuate the entire atmosphere of the freezer compartment in a matter of minutes. In normal operation, the exhaust housing 142 is preferably configured to channel any cryogen vapors originating from within the shrouded cryogen zone 125 to the exhaust blower 140 where the cryogen vapors are promptly evacuated or removed from the mechanical freezer compartment. Like the cryogen structure or enclosure 110, the exhaust housing 142 is disposed proximate the conveyor 112 and preferably includes one or more access doors 144 to facilitate periodic cleaning of the interior surfaces of the exhaust housing 142 and conveyor 112.

Although the exhaust housing 142 is depicted in FIG. 5 as a separate structure from the cryogen structure or enclosure 110, it should be appreciated that the two structures and functions can be integrated into a single cryogen arrangement. Similarly, although the illustrated embodiment preferably contemplates the cryogen injection to be applied toward the end of the product conveyor and near the exit of the mechanical freezer, such cryogen boosting of a mechanical freezer can be installed on most any part of the conveyor within the mechanical freezer.

FIG. 6 is a partial cut-away illustration of a cryogen injection system including a cryogen structure or enclosure defining a shrouded cryogen zone over a portion of a conveyor near the top of a mechanical spiral freezer. As seen therein, the cryogen structure or enclosure 150 is disposed in the freezer compartment 154 over a portion of the spiral conveyor 152 and preferably near the top of the spiral conveyor 152 and the exit of the freezer compartment 154. The illustrated cryogen structure or enclosure 150 is mounted on the existing support structure 158 typically found in many mechanical spiral freezers and is shown confining the space above an arcuate path of about 90 degrees along the spiral conveyor 152. The cryogen structure or enclosure 150 defines a shrouded cryogen zone 155 where carbon dioxide or nitrogen is injected at the food product on the spiral conveyor 152 by means of a cryogen injection system 160. The actual size and configuration of the enclosure is very much dependent of the sizing and orientation of the cryogen injection system but should not significantly affect the air flow and operation of the mechanical freezer.

Similar to the embodiment illustrated in FIG. 5, the cryogen injection system 160 of FIG. 6 preferably includes a plurality of cryogen injection nozzles 162 each coupled to a cryogen manifold. A source of cryogen (not shown) is supplied via conduits 166 to the cryogen manifold. The cryogen injection system 160 is preferably controlled by a micro-processor based controller (not shown) that governs the cryogen injection profiles or patterns, including cryo-boost process activation (on), de-activation (off), cryogen injection flow rate, duration, frequency, etc. The cryogen structure or enclosure 150 also includes one or more access doors 158 to facilitate periodic cleaning of the shrouded cryogen zone 155, cryogen injectors 162 and conveyor 152. Although not shown, the cryogen boost arrangement for a mechanical spiral freezer would also include the cryogen exhaust housing and exhaust blower located near to the shrouded zone 155 and configured to evacuate any cryogen vapors originating from within the shrouded cryogen zone 155 from the mechanical spiral freezer compartment.

It has also been found that providing an intermittent cryogen injection pattern or profile enhances the efficiency associated with the cryogen injection system and use of cryogen, particularly for nitrogen based cryo-boost arrangements. The cryogen injection is preferably controlled by means of the controller to cause intermittent flow of the cryogen through the nozzles throughout the entire cryo-boost cycle. The injection cycles for each of the nozzles during the cryo-boost cycle may also be staged such that cryogen is always being delivered via one or more nozzles but not all nozzles are concurrently injecting the cryogen. Since much of the cold cryogen vapors are promptly exhausted, the intermittent cycling of the cryogen minimizes or avoids over-injecting cryogen during the cryo-boost cycle. Continuous cryogen injection from a single nozzle can also lead to localized over-freezing of the food product as well as damage or degradation in performance of the nozzle. The on and off cycle times for cryogen injection through the nozzle or a plurality of nozzles can be periodic or aperiodic and the preferred duration of each on or off cycle as well as other injection parameters are set by the user or otherwise programmed into the micro-processor based controller.

The enclosures illustrated in FIGS. 5 and 6 defining a single cryogen zone depict the cryogen injection system fully disposed inside the enclosures. Alternative configurations of the present cryo-boost system would include an arrangement with smaller enclosures and only a portion of the cryogen injection system, such as the nozzles or the distal end of the nozzles, disposed within the enclosure. Still further contemplated arrangements envision a plurality of shrouded cryogen nozzles each disposed proximate the conveyor and defining a plurality of localized cryogen zones within the mechanical freezer compartment.

In an alternate embodiment, the cold exhaust disposed proximate the cryogen injection system can also be sized to operate, when needed, as the rapid exhaust and evacuate the entire freezer atmosphere when access to the freezer compartment is desired. Similarly, the cold exhaust could be configured to recycle a portion of the cryogen vapors back to freezer compartment based on various temperature and command inputs. If the cold exhaust is configured to recycle a portion of the cryogen vapors back to freezer compartment, the remaining portion of the cold vapors would preferably be vented or directed to an alternative use such as cooling the external condenser of the mechanical freezer.

The cryogen exhaust blower or cold exhaust is preferably located at or near the cryogen injection system. By co-locating the cryogen injection system and cryogen or cold exhaust, the refrigeration capacity supplied by the cryogen injection is applied directly to the food product within or near the shrouded cryogen zone or localized cryogen zones while the resulting cryogen vapor is subsequently exhausted by the cryogen exhaust blower. Although controlling the speed of the cryogen exhaust blower or other such that it is proportional to or directly related to the injection rate of cryogen is preferred, it is possible to control the cryogen exhaust system independent from the control of the cryogen injection system or control the exhaust and injection subsystems based on different parameters or operating conditions. What is important is that the control of the cryogen injection system and the control of the cryogen exhaust system operate to maintain the mechanical freezer compartment at or above a prescribed temperature set point so as to not adversely affect the mechanical refrigeration capacity associated with the mechanical freezer.

Another important aspect of the cold exhaust system is the exhaust fan speed and exhaust gas temperature. Whatever the intended use of the cold exhaust, whether it be a stand-alone cryogen exhaust proportionally tied to the rate of cryogen injection or a dual purpose exhaust functioning both a rapid exhaust and primary cryogen exhaust, it is important that the fan speed of the cold exhaust be sufficiently fast to prevent ice formation in the cold exhaust circuits and equipment. Generally, the exhausted cryogen vapors tend to warm as they travel through the exhaust conduits and exhaust blower. The design of the cold exhaust system, and in particular, the cold exhaust fan speed should ensure the temperature of the cold exhaust in the cold exhaust conduits is sufficiently low to avoid ice formation in all operating conditions.

As described herein, the present system and method for cryogenic enhancement to mechanical freezer systems provides a safe and low cost alternative that improves the performance and efficiency of the mechanical freezer system. One of the many advantages the present system and method has over prior art cryogenic enhancements to mechanical freezer systems is the disclosed safety features that prevent access or egress into the freezer compartment when the cryo-boost is activated and/or until the atmosphere within the freezer compartment is identified as safe and breathable. Another safety-related advantage embodied in the present system is realized by coupling the control of the rapid exhaust to atmosphere monitoring within the freezer compartment.

Other advantages and key aspects of the present invention are the operative controls the cryogen injection system and cryogen exhaust system to focus the cryogen in a shrouded or localized cryogen zone and maintain a reasonable pressure within the mechanical freezer compartment and maintain the mechanical freezer compartment at or above a prescribed temperature set point so as to not adversely affect the mechanical refrigeration capacity associated with the mechanical freezer.

While the present invention has been described with reference to a preferred embodiment, numerous changes, additions and omissions may be made without departing from the spirit and scope of the present invention, as defined by the appended claims.

What is claimed is:

1. A cryogenic enhanced mechanical freezer system comprising:
a mechanical freezer adapted for freezing food products, the mechanical freezer including a conveyor disposed within a mechanical freezer compartment;
an enclosure disposed around a portion of the conveyor in the mechanical freezer compartment to define a shrouded zone;
a cryogen injection system adapted to directly inject cryogen into the shrouded zone;
one or more temperature sensors disposed in the freezer compartment and adapted to ascertain the temperature within the mechanical freezer compartment;
an exhaust system having a first exhaust blower disposed proximate to the shrouded zone and adapted to evacuate cryogen vapors originating from the shrouded zone to a location outside the mechanical freezer compartment; and
a freezer control system adapted to control the mechanical freezer, the exhaust system, and cryogen injection system in response to inputs from the one or more temperature sensors and wherein the exhaust system and cryogen injection system are proportionally controlled.

2. The system of claim 1 wherein the freezer control system is responsive to inputs received from the one or more temperature sensors and controls the cryogen injection system and exhaust system to maintain the mechanical freezer compartment at or above a prescribed temperature set point so as to not adversely affect the mechanical refrigeration capacity associated with the mechanical freezer.

3. The system of claim 1 wherein the freezer control system is responsive to inputs received from the one or more temperature sensors and controls the cryogen injection system to inject cryogen only if the temperature in the mechanical freezer compartment is above a prescribed temperature set point so as to not adversely affect the mechanical refrigeration capacity associated with the mechanical freezer.

4. The system of claim 1 wherein the exhaust system further comprises a second exhaust blower disposed in the mechanical freezer compartment to rapidly evacuate the atmosphere from the mechanical freezer compartment when access to the freezer compartment is needed.

5. The system of claim 4 wherein the cryogen injection system and exhaust system are controlled such that the exhaust system continuously removes cryogen vapors when the cryogen injection system is active and rapidly evacuates cryogen vapors from the freezer compartment when the cryogen injection system is inactive and access to the freezer compartment is needed.

6. The system of claim 1 further comprising:
a gas analyzer disposed in operative association with the freezer compartment and adapted to monitor concentrations of the cryogen vapors within the freezer compartment and provide inputs to the freezer control system; and
one or more freezer compartment interlocks operatively coupled to the freezer control system;
wherein the freezer compartment interlocks prevent access into the freezer compartment if concentrations of the cryogen vapors within the freezer compartment exceed prescribed limits or if the cryogen injection system is injecting the cryogen.

7. The system of claim 6 wherein the freezer compartment interlocks further comprise:
a door handle cover moveably attached to the freezer compartment proximate a door handle, the door handle cover adapted to move between a first position that shrouds the door handle and a second position exposing the door handle; and
a retaining mechanism adapted to lock the door handle cover in the first position if concentrations of the cryogen vapors within the freezer compartment exceed prescribed limits or if the cryogen injection system is injecting the cryogen.

8. The system of claim 6 wherein the cryogen is carbon dioxide and the gas analyzer monitor concentrations of carbon dioxide within the freezer compartment.

9. The system of claim 6 wherein the cryogen is nitrogen and the gas analyzer monitor concentrations of oxygen within the freezer compartment.

10. A cryogenic enhanced mechanical freezer system comprising:
a mechanical freezer adapted for freezing food products, the mechanical freezer including a conveyor disposed within a mechanical freezer compartment;
a cryogen injection system including a plurality of nozzles disposed proximate the conveyor to define one or more localized cryogen zones, the cryogen injection system adapted to inject cryogen directly at the food products within the one or more localized cryogen zones;
a temperature sensor disposed in the freezer compartment and adapted to ascertain the temperature within the mechanical freezer compartment;
an exhaust system having a first exhaust blower adapted to evacuate cryogen vapors originating from the localized cryogen zones to a location outside the mechanical freezer compartment; and
a freezer control system adapted to control the mechanical freezer, the exhaust system, and cryogen injection system in response to inputs from the temperature sensor to maintain the mechanical freezer compartment at or above a prescribed temperature set point so as to not adversely affect the mechanical refrigeration capacity associated with the mechanical freezer.

11. The system of claim 10 wherein the freezer control system proportionally controls the amount of cryogen introduced via the cryogen injection system and the speed of the exhaust blower.

12. The system of claim 10 wherein the cryogen is nitrogen and the cryogen injection system injects the cryogen via the nozzles in an intermittent pattern into the one or more localized cryogen zones in the mechanical freezer compartment.

13. The system of claim 10 wherein the exhaust system further comprises a second exhaust blower disposed in the mechanical freezer compartment to rapidly evacuate the atmosphere from the mechanical freezer compartment when access to the freezer compartment is needed.

14. The system of claim 13 wherein the cryogen injection system and exhaust system are controlled such that the exhaust system continuously removes cryogen vapors when the cryogen injection system is active and rapidly evacuates cryogen vapors from the freezer compartment when the cryogen injection system is inactive and access to the freezer compartment is needed.

15. The system of claim 10 further comprising:
a gas analyzer disposed in operative association with the freezer compartment and adapted to monitor concentrations of the cryogen vapors within the freezer compartment and provide inputs to the freezer control system; and
one or more freezer compartment interlocks operatively coupled to the freezer control system;
wherein the freezer compartment interlocks prevent access into the freezer compartment if concentrations of the cryogen vapors within the freezer compartment exceed prescribed limits or if the cryogen injection system is injecting the cryogen.

16. The system of claim 15 wherein the freezer compartment interlocks further comprise:
a door handle cover moveably attached to the freezer compartment proximate a door handle, the door handle cover adapted to move between a first position that shrouds the door handle and a second position exposing the door handle; and
a retaining mechanism adapted to lock the door handle cover in the first position if concentrations of the cryogen vapors within the freezer compartment exceed prescribed limits or if the cryogen injection system is injecting the cryogen.

17. A method of freezing foodstuffs in a mechanical freezer system comprising the steps of:
mechanically refrigerating a freezer compartment;
sensing the temperature in the freezer compartment;
controllably injecting a cryogen directly into a shrouded zone in the freezer compartment proximate the foodstuffs based on the temperature of the freezer compartment to cryogenically enhance the freezing of the foodstuffs; and
controllably exhausting the cryogen vapors originating from the shrouded zone to a location outside the freezer compartment;
wherein the injecting of the cryogen and exhausting of the cryogen vapors are controlled in response to the temperature in the freezer compartment to maintain the freezer compartment at or above a prescribed temperature set point so as to not adversely affect the mechanical refrigeration capacity associated with the mechanical freezer system.

18. The method of claim 17 further comprising the step of rapidly evacuating the cryogen vapors from the freezer compartment when access to freezer compartment is required.

19. The method of claim 17 wherein the cryogen is nitrogen and the step of injecting cryogen further comprises injecting the cryogen in an intermittent pattern into the shrouded zone in the freezer compartment.

20. The method of claim 17 further comprising the steps of:
monitoring the concentrations of selected gases within the freezer compartment; and
interlocking any entry into the freezer compartment to prevent access into the freezer compartment when concentrations of the selected gases within the freezer compartment exceed prescribed limits or when the cryogen injection system is injecting the cryogen.

21. The method of claim 20 wherein the cryogen is carbon dioxide and the step of monitoring concentrations of selected gases further comprises monitoring concentrations of carbon dioxide within the freezer compartment.

22. The method of claim 20 wherein the cryogen is nitrogen and the step of monitoring concentrations of selected gases further comprises monitoring concentrations of oxygen within the freezer compartment.
